(19) United States
(12) Patent Application Publication
(10) Pub. No.: US 2024/0131869 A1
(43) Pub. Date: Apr. 25, 2024

(54) TIRE HAVING A REGROOVABLE TREAD

(71) Applicant: COMPAGNIE GENERALE DES ETABLISSEMENTS MICHELIN, Clermont-Ferrand (FR)

(72) Inventors: LUC BESTGEN, Clermont-Ferrand (FR); PATRICK DAYET, Clermont-Ferrand (FR); STEPHANE HEBERT, Clermont-Ferrand (FR)

(21) Appl. No.: 18/277,789

(22) PCT Filed: Feb. 17, 2022
(86) PCT No.: PCT/FR2022/050287

§ 371 Date: Aug. 17, 2023

(30) Foreign Application Priority Data
Feb. 25, 2021 (FR) FR 2101845

(51) Int. Cl. B60C 11/02; B29D 30/54

(52) U.S. Cl. CPC B60C 11/02; B29D 30/54

(57) ABSTRACT

The invention relates to a tire (1) that can be regrooved at least once, and the tread of which has at least one re-cuttable groove (3).

According to the invention, after regrooving, the height (H_{R}) of said at least one re-cut groove (3) is greater than or equal to 70% of the groove height (H_{N3}) of said at least one re-cuttable groove of the tire when new.

The present invention relates to a tire having a radial carcass reinforcement, and more particularly to a tire intended to be fitted to vehicles that bear heavy loads, such as lorries, tractors, trailers or buses, for example.

In general, in tires of the heavy-duty type, the carcass reinforcement is anchored on either side in the region of the bead and is radially surmounted by a crown reinforcement made up of at least two layers that are superimposed and formed of threads or cords, which are parallel in each layer and are crossed from one layer to the next, forming angles of between 10° and 45° with the circumferential direction. Said working layers, that form the working reinforcement, can also be covered with at least one layer, called protective layer, formed of reinforcing elements, called elastic reinforcing elements, that are advantageously metal and extensible. It may also comprise a layer of metal threads or cords of low extensibility that form an angle of between 45° and 90° with the circumferential direction, this ply, referred to as triangulation ply, being situated radially between the carcass reinforcement and the first crown ply, referred to as working ply, which are formed of parallel threads or cords that exhibit angles at most equal to 45° in terms of absolute value. The triangulation ply forms, with at least said working ply, a triangulated reinforcement, which exhibits little deformation under the various stresses to which it is subjected, the triangulation ply essentially serving to absorb the transverse compressive forces that act on all the reinforcing elements in the crown region of the tire.

Cords are said to be inextensible when said cords exhibit, under a tensile force equal to 10% of the breaking force, a relative elongation at most equal to 0.2%.

Cords are said to be elastic when said cords exhibit, under a tensile force equal to the breaking load, a relative elongation at least equal to 3% with a maximum tangent modulus of less than 150 GPa.

The circumferential direction of the tire, or longitudinal direction, is the direction tangential to the periphery of the tire and defined by the direction of running of the tire.

The axis of rotation of the tire is the axis about which it turns in normal use.

A radial or meridian plane is a plane that contains the axis of rotation of the tire.

The circumferential median plane, or equatorial plane, is a plane that is perpendicular to the axis of rotation of the tire and that divides the tire into two halves.

The transverse or axial direction of the tire is parallel to the axis of rotation of the tire. An axial distance is measured in the axial direction. The expression “axially on the inside of or axially on the outside of, respectively” means “the axial distance of which, measured from the equatorial plane, is less than or greater than, respectively”.

The radial direction is a direction that intersects the axis of rotation of the tire and is perpendicular thereto. A radial distance is measured in the radial direction. The expression “radially on the inside of or radially on the outside of, respectively” means “the radial distance of which, measured from the axis of rotation of the tire, is less than or greater than, respectively”.

Radially on the outside of the crown reinforcement is the tread, usually made up of polymeric materials intended to come into contact with the ground in the contact patch in which the tire makes contact with the ground.

It is known to provide the tread, i.e. the part of the tire intended to come into contact with the ground during running and to be worn during running, with a tread pattern formed of raised elements delimited by cuts such as grooves, regardless of whether they are circumferentially, transversely or obliquely oriented. The aim of such a tread pattern is to impart good performance properties to the tread, when running on dry road surfaces and on road surfaces covered with water, especially when raining.

In order to improve the performance of the treads without however reducing the shear stiffnesses of said treads too much, it is known practice to form, on the tread surface, a plurality of transversely- or obliquely-oriented edge corners in order to bite into the film of water on a road surface in order to ensure good contact between the tread and the road surface. One means of obtaining such edge corners consists in providing the tread with a plurality of cuts, these cuts having the form of grooves or the form of sipes. A distinction is made, in the present application, between sipes and grooves in that sipes have a width suitable for allowing, during running, at least partial contact between the facing walls delimiting these sipes and in particular when they are in the contact patch in contact with the ground, which would not be the case for grooves under normal conditions of use of the tire.

For the purposes of the invention, a longitudinally-oriented cut is a cut in which the mean plane of at least a portion of the walls of said cut forms with a longitudinal plane an angle of less than 10°. This angle formed with a longitudinal plane may be oriented in one direction or the other relative to said longitudinal plane. A longitudinally-oriented cut may further be a cut in which the walls undulate or zig-zag about a mean plane as has just been described.

For the purposes of the invention, a transversely-oriented cut is a cut in which the mean plane of at least a portion of the walls of said cut forms with a radial plane an angle of less than 35°. This angle formed with a radial plane may be oriented in one direction or the other relative to said radial plane. A transversely-oriented cut may also be a cut of which the walls undulate or zig-zag about a mean plane as has just been described.

For the purposes of the invention, an obliquely-oriented cut is a cut in which the mean plane of at least a portion of the walls of said cut forms with a radial plane an angle of between 35° and 80°. This angle formed with a radial plane may be oriented in one direction or the other relative to said radial plane. An obliquely-oriented cut may also be a cut of which the walls undulate or zig-zag about a mean plane as has just been described.

Combined with this requirement to improve the grip performance by the presence of edge-corners formed by the transverse cuts, it is also required that the performance properties of a tread be durable, that is to say that satisfactory performance properties be achieved even after more or less advanced partial wear. Partial wear of a tread is intended to mean a state of wear corresponding to a tread thickness at most equal to the total tread thickness able to be worn before having to change the tire, especially for regulatory reasons.

The grooves generally comprise tread-wear indicators, which are small platforms of vulcanized rubber compound covering the bottoms of these grooves over a certain circumferential length, these tread-wear indicators indicating the minimum depth of tread pattern that must legally remain on the tread in use. The tread patterns for heavy-duty vehicles are regroovable (re-grooving being an operation whereby new grooves can be cut) and tires that have such tread patterns bear the word (in English) “Regroovable” or the symbol “U” on their sidewall. Regrooving makes it possible on the one hand to extend the grip potential of the heavy-duty tire and, on the other hand, to significantly increase the distance over which it is able to be run.

The regrooving of heavy-duty tires is a usual operation that is authorised for the sake of safety and for the increase in cost-effectiveness that it affords. By way of example, it is explicitly permitted by the French highway code (Code de la Route Article 4 of the decree of 24 Oct. 1994) and recommended by the ETRTO and by AFNOR (Standard NFR12714). For purposes of this operation, the manufacturers are required to provide regrooving diagrams that the technicians tasked with regrooving are obliged to follow.

The groove heights on a new tire can be measured and the groove heights after regrooving can be deduced from these regrooving diagrams.

As is known per se, a groove can be re-cut using a heated rounded blade, which is still often manipulated by a human operator. Said blade, connected to a frame that bears against the tread surface, can be used by hand so as to follow the line of the groove on the tread surface fairly faithfully, even when the line of the groove is not rectilinear.

Regrooving makes it possible to restore sharp edge-corners and is usually intended to restore a tread-pattern height that corresponds to that of a heavy-duty tire at the mid-wear point. The usual recommendations aim for a height, after regrooving, of 5 to 6 mm made up of a re-cut groove of 3 to 4 mm and of 2 mm of remaining height; in practice, regrooving is often performed earlier than this with remaining heights of between 4 and 5 mm, leading to a height, after regrooving, of 7 to 9 mm for as-new tire tread pattern heights comprised between 12 and 20 mm.

Regrooving a tire offers a number of advantages. First of all, by restoring the tread-pattern height to the tire, regrooving makes it possible to extend the life of the tire.

Further, because the regrooving is performed when the tread thickness is at its smallest and therefore when the tire is exhibiting its lowest rolling resistance, the distance over which the tire can be run is extended when the rolling resistance is at its lowest.

The inventors have set themselves the task of being able to provide tires exhibiting even better performance properties in terms of rolling resistance while at the same time maintaining ever greater running distances and good properties of grip on wet ground.

This objective has been achieved according to the invention by a tire, that can be regrooved at least once, comprising a crown reinforcement, itself capped radially by a tread made of at least one elastomer compound and connected to two beads via two sidewalls, said tread having at least one re-cuttable groove forming at least one tread-pattern element that constitutes the tread pattern of the tire, having a height between the bottom of said at least one groove and the tread surface when the tire is new. After regrooving, the height of said at least one re-cut groove is greater than or equal to 70% of the groove height of said at least one re-cuttable groove of the tire when new.

For the purposes of the invention, the groove height is measured in a meridian section of the tire and corresponds to the distance measured between the radially outer surface of the tread, which forms the surface in contact with the ground, and which is extrapolated in order to disregard the cuts, and the surface of the bottoms of the tread pattern, said distance being measured in a direction normal to the radially outer surface of the tread. The bottoms of the tread pattern are the radially innermost points of the recessed zones of the tread, disregarding the presence of elements such as tread-wear indicators, wells indicating regrooving depth, or any other element the sum of the surface areas of which represents less than 15% of the total surface area of the cut.

The groove height of said at least one re-cuttable groove of the regroovable tire when new is thus measured on a new tire. The height of said at least one re-cut groove may likewise be measured when the tire is regrooved; the height of said at least one re-cut groove may also be determined in the way explained hereinabove from the new tire and from the regrooving diagram supplied by the manufacturer.

Advantageously according to the invention, the height corresponding to the distance between the tread surface when new and the bottom of the grooves after the last regrooving operation is greater than or equal to 200% of the height H_{N} between the bottom of the groove and the tread surface when the tire is new. Advantageously also, the height corresponding to the distance between the tread surface when new and the bottom of the grooves after the last regrooving operation is greater than or equal to 250% of the height H_{N} between the bottom of the groove and the tread surface when the tire is new.

The height corresponding to the distance between the tread surface when new and the bottom of the grooves after the last regrooving operation may be determined when the tire is regrooved or else may also be determined in the way explained hereinabove from the new tire and from the regrooving diagram supplied by the manufacturer.

Tests conducted on tires according to the invention have demonstrated that, by comparison with usual regroovable tires, the performance in terms of rolling resistance is improved while at the same time maintaining similar properties of grip on wet ground and for substantially identical running distances that can be covered before the tire becomes completely worn.

The inventors have been able to demonstrate that the combination of a tread thickness substantially identical to that of a tire of more conventional design and as-new tire groove heights that are reduced in comparison with those of a tire of more traditional design, makes it possible to significantly improve the performance in terms of rolling resistance.

Specifically, for tread thicknesses similar to those of tires of more traditional design, having groove heights after regrooving that are greater than 70% of the groove height when new signifies that the height of the grooves when new is less by comparison with that of the tires of more traditional design.

As stated previously, the regrooving intended for tires of more traditional design leads to groove heights that are less than half the height of the grooves when new. According to the invention, for a given tread thickness, the regrooving of the tread therefore probably needs to be performed earlier, which is to say for a lower degree of tread wear, than is the case with a tire of more traditional design.

The inventors have thus been able to demonstrate, that this early regrooving of the tread of the tire according to the invention makes it possible to improve its performance in terms of rolling resistance appreciably while maintaining wearing and wet grip performance.

By the same principle, the tires according to the invention may be provided with a tread which, when new, has a greater thickness than that of traditional tires and may lead to rolling resistance performance substantially identical to that of said traditional tires, in association with a much greater running distance, the tire according to the invention moreover maintaining satisfactory wet-grip performance right up until the point at which the tire is completely worn. Specifically, on the one hand, the thicker tread has more material that can be worn away, and can therefore potentially be run over a greater distance. On the other hand, counter to the expectation of poorer performance in terms of rolling resistance on account of a greater mass of elastomer in the tread, the design of the tire according to the invention limits tread deformation and makes it possible to obtain rolling resistance performance substantially equivalent to that of said tires of more traditional design.

According to a first embodiment of the invention, said at least one re-cuttable groove is circumferential.

According to a second embodiment of the invention, said at least one re-cuttable groove is transverse.

According to a third embodiment of the invention, said at least one re-cuttable groove is oblique.

According to other embodiments of the invention, the tire has a combination of circumferential and/or transverse and/or oblique re-cuttable grooves.

Whether they all have the same orientation or have a plurality of orientations, the invention advantageously plans for all of the grooves of the tire to be re-cut according to the invention during the one same step.

According to an advantageous variant of the invention, after regrooving, the height of said at least one re-cut groove is greater than or equal to 85% of the height of said at least one re-cuttable groove of the tire when new, and more preferably still is greater than 95% of the tread-pattern height of the tire when new.

According to one embodiment of the invention, at least one groove can be re-cut at least twice. According to this embodiment, it may even be possible to increase the rolling resistance performance by planning groove depths when new which are even smaller while still meeting wet grip performance requirements.

According to this embodiment and in the case of a plurality of grooves with the same orientation or else with a plurality of orientations, the invention advantageously plans for all of the grooves of the tire to be re-cut simultaneously during each regrooving operation.

Advantageously also, according to this embodiment of the invention, the elastomer compound regrooved during the first regrooving operation is different from the elastomer compound regrooved during the second regrooving operation. For example, the radially innermost elastomer compound contains no black filler, so that a colour contrast is exhibited when this compound appears at the time of the first regrooving operation. Such an arrangement may notably make the regrooving steps easier.

According to other embodiments of the invention, the tread comprises depth indicators in the form, for example, of wells or incisions of small non-zero width placed in the bottom of the groove either parallel to the direction of said groove or perpendicular to said direction, or both simultaneously, the means of indicating the minimum and maximum depths then being the geometric shape of the bottom of the depth-indicating incision.

Advantageously according to the invention, the regroovable elastomer compound is different from at least part of the elastomer compound that constitutes the tread. Such an embodiment may be obtained by coextrusion of the compounds during the preparation of the semi-finished product or products intended to at least partially form the tread.

Either the one or the other of the embodiments of the invention set out hereinabove may also be associated with the creation of a complex trade consisting for example of at least two radially superposed layers of elastomer compounds.

According to one embodiment of the invention, the crown reinforcement of the tire is formed of at least two working crown layers of inextensible reinforcing elements, crossed from one layer to the other, forming, with the circumferential direction, angles of between 10° and 45°.

According to other embodiments of the invention, the crown reinforcement also comprises at least one layer of circumferential reinforcing elements.

One embodiment of the invention also makes provision for the crown reinforcement to be supplemented radially on the outside by at least one additional layer, called protective layer, of reinforcing elements, called elastic reinforcing elements, oriented relative to the circumferential direction with an angle of between 10° and 45° and in the same direction as the angle formed by the inextensible elements of the working layer that is radially adjacent thereto.

According to any one of the embodiments of the invention mentioned above, the crown reinforcement may be further supplemented, radially on the inside between the carcass reinforcement and the radially interior working layer closest to said carcass reinforcement, by a triangulation layer made of inextensible steel metal reinforcing elements and forming, with the circumferential direction, an angle greater than 60° in the same direction as that of the angle formed by the reinforcing elements of the radially closest layer of the carcass reinforcement.

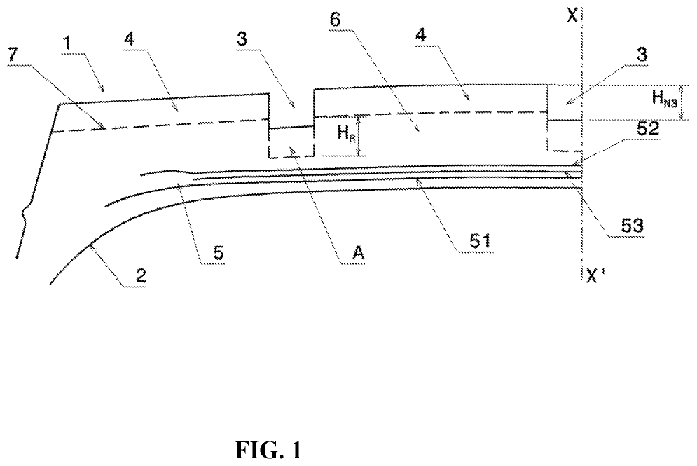

Further details and advantageous features of the invention will become apparent hereinafter from the description of exemplary embodiments of the invention, with reference to FIGS. 1 to 3 in which:

FIG. 1 is a schematic meridian view of a tire according to a first exemplary embodiment of the invention,

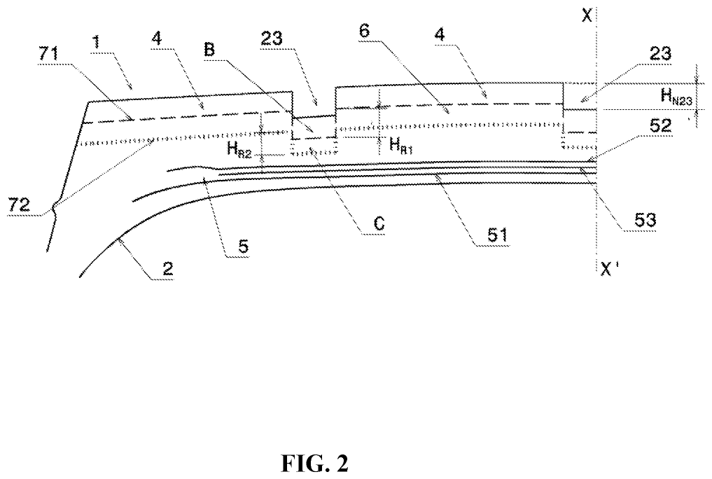

FIG. 2 is a schematic meridian view of a tire according to a second exemplary embodiment of the invention,

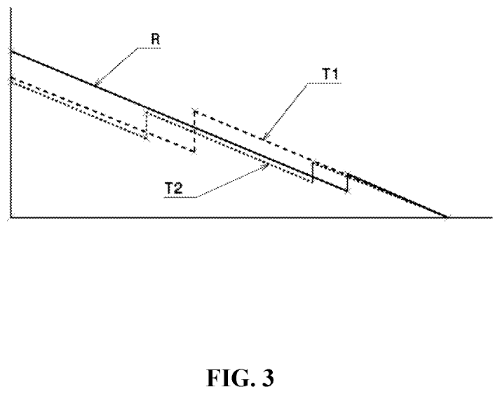

FIG. 3 is a schematic depiction of the rolling resistance of a tire as it wears, for a reference tire and for two tires according to the invention.

In order to make them easier to understand, FIGS. 1 and 2 are not drawn to scale. FIGS. 1 and 2 show only a half-view of a tire, which extends symmetrically with respect to the axis XX′, which represents the circumferential median plane, or equatorial plane, of a tire.

In FIGS. 1 and 2, the tire 1, of dimension 315/70R22.5, comprises a radial carcass reinforcement 2 anchored in two beads, around bead wires (not depicted). The carcass reinforcement 2 is formed of a single layer of metal cords. The carcass reinforcement 2 is hooped by a crown reinforcement 5, itself capped by a tread 6. The tread comprises three grooves 3 forming four ribs 4 and the two axially-central ribs are cut with oblique grooves that pass all the way through and are not depicted in FIGS. 1 and 2.

The lower sidewall regions and the beads of the tire 1 are in particular not depicted in the figures.

In FIGS. 1 and 2, the crown reinforcement 5 is formed radially from the inside to the outside:
of a first working layer 51 formed of inextensible metal cords which are continuous across the entire width of the ply and oriented at an angle α1,
of a layer of circumferential reinforcing elements 53, which is formed of 21.23 elastic steel metal cords, with a pitch spacing of 2 mm, and
of a second working layer 52 formed of inextensible metal cords which are continuous across the entire width of the ply, oriented at an angle α2 and crossed with the metal cords of the first working layer.

The axial width L₅₁ of the first working layer 51 is equal to 246 mm.

The axial width L₅₂ of the second working layer 52 is equal to 228 mm.

The axial width L₅₃ of the layer of circumferential reinforcing elements 53 is itself equal to 200 mm.

In FIG. 1, according to the invention, the grooves 3 are of re-cuttable type. As illustrated in FIG. 1, the grooves 3 consist of a single layer A forming the bottom of the grooves when new and corresponding to a single regrooving operation.

The height H_{N3} of the grooves 3 when the tire is new, is equal to 7.5 mm.

The height H_{R} of the grooves 3 after regrooving is equal to 9.5 mm and therefore represents 127% of H_{N3}.

This height H_{R} corresponds to a regrooving by 7.5 mm while there still remains 2 mm of the initial groove height, which value is close to the legal limit generally permitted, corresponding to the minimum height and to the height of the tread-wear indicators. This limit is indicated by the line 7 in FIG. 1.

The height, that cannot be measured before this regrooving and that corresponds to the distance between the tread surface when new and the bottom of a groove 3 after regrooving, is thus equal to 15 mm. The ratio of this non-measurable height equal to 15 mm to the height H_{N3} is equal to 2 and therefore is indeed greater than or equal to 200%.

The height H_{R}, measured after regrooving, and the height, that cannot be measured before regrooving and that corresponds to the distance between the tread surface when new and the bottom of a groove 3 after regrooving, can also be determined on a new tire from the regrooving diagrams supplied by the manufacturer as explained earlier.

FIG. 2 illustrates a tire the grooves 23 of which can be re-cut twice. The grooves 23 when new consist of two layers B and C forming the bottom of the grooves when new and corresponding to these two regrooving operations.

The height H_{N23} of the grooves 23 when the tire is new, is equal to 6 mm.

The height H_{R1} of the grooves 23 after the first regrooving operation is equal to 7 mm and therefore represents 117% of H_{N23}.

This height H_{R1} corresponds to a regrooving by 5 mm while there still remains 2 mm of the initial groove height, which value is close to the legal limit generally permitted, corresponding to the minimum height and to the tread-wear indicators. This limit is indicated by the line 71 in FIG. 2.

The height, that cannot be measured before a first regrooving operation and that corresponds to the distance between the tread surface when new and the bottom of the groove after the first regrooving operation, is thus equal to 11 mm.

The height H_{R1}, measured after the first regrooving operation, and the height, that cannot be measured before a first regrooving operation and that corresponds to the distance between the tread surface when new and the bottom of the groove after the first regrooving operation, can also be determined on a new tire from the regrooving diagram supplied by the manufacturer as explained earlier.

The height H_{R2} of the grooves 23 after the second regrooving operation is equal to 6 mm and therefore represents 100% of H_{N23}. And the height H_{R2} of the grooves 23 after the second regrooving operation represents 86% of H_{R1}.

This height H_{R2} corresponds to a regrooving by 4 mm while there still remains 2 mm of the initial groove height, which value is close to the legal limit generally permitted, corresponding to the minimum height. This limit is indicated by the line 72 in FIG. 2.

The height, that cannot be measured before the two regrooving operations and that corresponds to the distance between the tread surface when new and the bottom of the grooves 23 after the second regrooving operation, is thus equal to 15 mm. The ratio of this non-measurable height equal to 15 mm to the height H_{N23} is equal to 2.5 and therefore is indeed greater than or equal to 200%.

The height H_{R2}, measured after the second regrooving operation, and the height, that cannot be measured before the two regrooving operations and that corresponds to the distance between the tread surface when new and the bottom of the grooves after the second regrooving operation, can also be determined on a new tire from the regrooving diagram supplied by the manufacturer as explained earlier.

The tire thus depicted in FIG. 2 is anticipating two regrooving operations at various stages in the wearing of the tire. Advantageously according to the invention, the grooves are re-cut simultaneously in each regrooving step.

According to other variant embodiments of the invention, the re-cutting of the various grooves of a tire may be scheduled to be performed in a manner that is spread over time. According to these variant embodiments, the tire may comprise a proportion of grooves that can be re-cut just once, and of other grooves that can be re-cut a plurality of times. A tire could thus comprise a combination of grooves such as those illustrated in FIG. 1 and of grooves such as those illustrated in FIG. 2.

Tires were produced based on the elastomeric compound described hereinbelow by way of the compound of which the tread is formed.

| | Compound |
|---|---|
| NR | 80 |
| BR | 20 |
| N234 | 48 |
| 6PPD - 1.3DIMETHYL | 3 |
| BUTYL PHENYL | |
| PARAPHENYLENE- | |
| DIAMINE | |
| ZnO | 3 |
| SULFUR | 1.5 |
| Accelerator (CBS) | 0.9 |

The values of the constituent ingredients are expressed in phr (parts by weight per hundred parts of rubber/elastomer).

A reference tire R similar to the one in the figures was produced to a configuration corresponding to the traditional embodiments for regrooving. It comprises a single regrooving layer at the bottom of the grooves, such that the height of the grooves after regrooving is equal to 5 mm and represents 42% of the height of the grooves when new, which is itself equal to 12 mm. This height after regrooving, which is equal to 5 mm, corresponds to a regrooving by 3 mm while there still remains 2 mm of the initial groove height, which value is close to the legal limit generally permitted, corresponding to the minimum height. The height, that cannot be measured before regrooving and that corresponds to the distance between the tread surface when new and the bottom of the grooves after regrooving, is thus equal to 15 mm.

As in the case of the tires according to the invention and as explained hereinabove, the height, measured after a first regrooving operation, and the height, that cannot be measured before regrooving and that corresponds to the distance between the tread surface when new and the bottom of the grooves afterwards, can also be determined on a new tire from the regrooving diagrams supplied by the manufacturer.

Tires T1 and T2 conforming to the invention were produced.

Tire T1 conforms to that depicted in FIG. 1.

Tire T2 conforms to that depicted in FIG. 2.

Measurements of grip on wet ground were taken on each of the tires under identical running conditions in accordance with the ISO 15222 standard. The results of the measurements are given in the following table; a value of 100 being assigned to the tire R when new. Values higher than 100 express superior grip performance.

| | | After | After |
|---|---|---|---|
| | New | regrooving once | regrooving twice |
| Tire R | 100 | 96 | |
| Tire T1 | 100 | 100 | |
| Tire T2 | 98 | 100 | 100 |

These values show that at all stages in the wearing of the tire the wet-grip properties are maintained.

Moreover, wearing tests were conducted to demonstrate substantially identical performance between the tires T1 and T2 according to the invention and the reference tire R. Specifically, the volume of elastomer compounds constituting the tread and that can be worn away during the course of the life of the tire and of the regrooving operation or operations is substantially the same for all three tires, leading to very similar tire lifespans. Tire life may be slightly superior for tires T1 and T2 in harsh-wear scenarios, and slightly inferior in what might be termed mild-wear scenarios, the difference in ranking being associated with the difference in tread stiffness, the depth of the grooves being of order one with reference to tread stiffness.

Rolling resistance measurements were also carried out on each of the tires under identical running conditions according to Regulation No 117 of the United Nations Economic Commission for Europe (UNECE). The results of the measurements are given in the following table, a value of 100 being assigned to the tire R when new. A value of 90 signifies that the coefficient of rolling resistance is reduced by 10% and corresponds to superior performance in terms of rolling resistance. Measurements were performed on a new tire and on a tire planed down to the level of the usual wear limit of around 2 mm on each of the tires R, T1 and T2. A measurement was performed again after each of the tires R, T1 and T2 had been regrooved, and then another measurement was performed on each of the tires R, T1 and T2 when they had been again planed down to the level of the usual wear limit of around 2 mm. Tire T2 was then measured once again after the second regrooving operation and then a final measurement was performed on this tire T2 after it had been planed down to the level of the usual wear limit of around 2 mm.

| | | | After | | After | |
|---|---|---|---|---|---|---|
| | | Wear | regrooving | Wear | regrooving | Wear |
| | New | limit | once | limit | twice | limit |
| Tire R | 100 | 68 | 72 | 62 | | |
| Tire T1 | 94 | 77 | 86 | 62 | | |
| Tire T2 | 92 | 80 | 86 | 70 | 75 | 62 |

FIG. 3 schematically illustrates how the rolling resistance of each of the tires R, T1 and T2 evolves from the as-new state to the end-of-life, namely over the 13 mm of wear of the tread. In FIG. 3, the ordinate axis represents the measured or estimated value of the rolling resistance of the tire, as a function of the height of tread pattern worn away, and the abscissa axis represents this height starting from 0 and ending at 13 mm. The 13 mm correspond to the 15 mm of tread provided on each of the tires R, T1 and T2, accounting for the 2 mm kept at the end-of-life of the tires, which value is close to the legal limit generally permitted.

The three lines plotted in this FIG. 3 correspond to each of the tires R, T1 and T2. Calculating the areas bounded by these three plotted lines makes it possible to estimate the mean rolling resistance of each of these tires over the use thereof. The results showed that tire T1 yields an improvement of 7% relative to tire R, and that tire T2 yields an improvement of 14% relative to tire R.

1.-9. (canceled)

10. A tire (1), that can be regrooved at least once, comprising a crown reinforcement (5), the crown reinforcement capped radially by a tread (6) made of at least one elastomer compound and connected to two beads via two sidewalls, the tread (6) having at least one re-cuttable groove (3) forming at least one tread-pattern element that constitutes a tread pattern of the tire, having a height (H_{N3}) between a bottom of the at least one re-cuttable groove (3) and a tread surface when the tire is new,
wherein, after regrooving, a height (H_{R}) of the at least one re-cuttable groove (3) is greater than or equal to 70% of a groove height (H_{N}) of the at least one re-cuttable groove (3) of the tire when new.

11. The tire (1) according to claim 10, wherein a height corresponding to a distance between the tread surface when new and the bottom of the at least one re-cuttable groove (3) after a regrooving operation is greater than or equal to 200% of the height (H_{N}) between the bottom of the at least one re-cuttable groove (3) and the tread surface when the tire is new.

12. The tire (1) according to claim 10, wherein the at least one re-cuttable groove (3) is circumferential.

13. The tire (1) according to claim 10, wherein the at least one re-cuttable groove (3) is transverse.

14. The tire (1) according to claim 10, wherein the at least one re-cuttable groove (3) is oblique.

15. The tire (1) according to claim 10, wherein the at least one re-cuttable groove (3) can be re-cut at least twice.

16. The tire (1) according to claim 15, wherein an elastomer compound regrooved during a first regrooving operation is different from an elastomer compound regrooved during a second regrooving operation.

17. The tire (1) according to claim 10, wherein a regroovable elastomer compound is different from at least part of the at least one elastomer compound that constitutes the tread.

18. The tire (1) according to claim 10, wherein the tread comprises, at least locally, at least two layers of elastomer compounds radially superposed in the tread.
